(19) United States
(12) Patent Application Publication
(10) Pub. No.: US 2018/0214984 A1
(43) Pub. Date: Aug. 2, 2018

(54) SUPPORTS INCLUDING CONDUITS FOR ADDITIVE MANUFACTURING SYSTEMS

(71) Applicant: General Electric Company, Schenectady, NY (US)

(72) Inventor: Juan Vicente Haro Gonzalez, Zurich (CH)

(21) Appl. No.: 15/418,999

(22) Filed: Jan. 30, 2017

(51) Int. Cl. B23K 26/342; B33Y 30/00; B29C 67/00; B28B 1/00; B23K 26/70; B33Y 40/00

(52) U.S. Cl. CPC B23K 26/342; B33Y 30/00; B29C 67/0077; B22F 2003/1058; B23K 26/702; B33Y 40/00; B28B 1/001

(57) ABSTRACT

Supports for additive manufacturing systems are disclosed. The supports positioned on a build plate of the additive manufacturing systems may include a build surface, a side surface positioned adjacent the build surface, and an outlet opening formed through the build surface. The outlet opening may be configured to be in fluid communication with an aperture formed through a surface of a component built above the build surface. The support may also include an inlet opening formed through one of the build surface or the side surface, and a conduit fluidly coupling the outlet opening and the inlet opening.

### BACKGROUND OF THE INVENTION

The disclosure relates generally to additive manufacturing systems, and more particularly, to supports including conduits for removing material positioned within channels formed through components built on the supports using additive manufacturing systems and processes.

Components or parts for various machines and mechanical systems may be built using additive manufacturing systems. Additive manufacturing systems may build such components by continuously layering powder material in predetermined areas and performing a material transformation process, such as sintering, on the powder material. The material transformation process may alter the physical state of the powder material from a granular composition to a solid material to build the component. The components built using the additive manufacturing systems have nearly identical physical attributes as conventional components typically made by performing machining processes on stock material.

Conventional additive manufacturing systems build components on large, solid build plates. These conventional build plates are often made of two inches (or more) of solid metal, for example stainless steel. While suitable for some components, the solid material forming the conventional build plates may make manufacturing components with unique features difficult. For example, some components manufactured on conventional build plates include channels formed therein. Some of these channels may include one aperture formed on and/or disposed through a surface that may contact, be built directly on and/or be obstructed by the conventional, solid build plate. As a result, the channel of the component that may be obstructed by the solid, conventional build plate may not be capable of being cleared of unsintered material, particles and/or debris before undergoing post-processes, such as polishing, coating and/or heat treatment. The inability to clear the channels formed in the component from unsintered material, particles and/or debris may result in undesirable build effects on the component after performing post-processes. For example, the unsintered material, particles and/or debris that may remain within the channels may become sintered when performing the post-processes on the component, which may result in partial or complete blockage of the channel within the component. Blockage of the channel may adversely affect the intended functionality and/or operation of the component built on the conventional build plate.

### BRIEF DESCRIPTION OF THE INVENTION

A first aspect of the disclosure provides a support positioned on a build plate of an additive manufacturing system, the support including: a build surface; a side surface positioned adjacent the build surface; an outlet opening formed through the build surface, the outlet opening configured to be in fluid communication with an aperture formed through a surface of a component built above the build surface; an inlet opening formed through one of the build surface or the side surface; and a conduit fluidly coupling the outlet opening and the inlet opening.

A second aspect of the disclosure provides a build plate for an additive manufacturing system, the build plate including a top surface; and a support positioned directly on the top surface, the support including: a build surface; a side surface positioned adjacent the build surface; an outlet opening formed through the build surface, the outlet opening configured to be in fluid communication with an aperture formed through a surface of a component built above the build surface; an inlet opening formed through one of the build surface or the side surface; and a conduit fluidly coupling the outlet opening and the inlet opening.

A third aspect of the disclosure provides an additive manufacturing system including: a build plate including a top surface; at least one laser positioned above the build plate; and a support positioned directly on the top surface of the build plate, the support including: a build surface; a side surface positioned adjacent the build surface; an outlet opening formed through the build surface, the outlet opening configured to be in fluid communication with an aperture formed through a surface of a component built above the build surface; an inlet opening formed through one of the build surface or the side surface; and a conduit fluidly coupling the outlet opening and the inlet opening.

The illustrative aspects of the present disclosure are designed to solve the problems herein described and/or other problems not discussed.

### BRIEF DESCRIPTION OF THE DRAWINGS

These and other features of this disclosure will be more readily understood from the following detailed description of the various aspects of the disclosure taken in conjunction with the accompanying drawings that depict various embodiments of the disclosure, in which:

FIG. 1 shows an isometric, exploded view of a component, a support and a portion of a build plate of an additive manufacturing system, according to embodiments.

FIG. 2 shows a front view of the component, the support and the portion of the build plate of FIG. 1, according to embodiments.

FIG. 3 shows a top view of a build plate of an additive manufacturing system, a plurality of supports and a plurality of components, according to embodiments.

FIG. 4 shows a front view of a component and a support including inlet openings formed on distinct sides of the support, according to embodiments.

FIG. 5 shows a front view of a component and a support including inlet openings formed on various sides and surfaces of the support, according to embodiments.

FIG. 6 shows a top view of the component and the support of FIG. 5, according to embodiments.

FIG. 7, shows an isometric exploded view of a component and a support including a single inlet opening and a single conduit, according to embodiments.

FIG. 8 shows a front view of a component, a support, a joist and a portion of a build plate of an additive manufacturing system, according to embodiments.

FIG. 9 shows a front view of two distinct components, two distinct supports and a portion of a build plate of an additive manufacturing system, according to embodiments.

FIG. 10 shows a front view of two distinct components, two distinct supports and a portion of a build plate of an additive manufacturing system, according to additional embodiments.

FIG. 11 shows a front view of two distinct components, two distinct supports and a portion of a build plate of an additive manufacturing system, according to further embodiments.

FIG. 12 shows a front view of two distinct components, two distinct supports and a portion of a build plate of an additive manufacturing system, according to another embodiment.

FIG. 13 shows a front view of two distinct components, two distinct supports and a portion of a build plate of an additive manufacturing system, according to alternative embodiments.

FIG. 14 shows a block diagram of an additive manufacturing process including a non-transitory computer readable storage medium storing code representative of a support according to embodiments of the disclosure.

It is noted that the drawings of the disclosure are not to scale. The drawings are intended to depict only typical aspects of the disclosure, and therefore should not be considered as limiting the scope of the disclosure. In the drawings, like numbering represents like elements between the drawings.

### DETAILED DESCRIPTION OF THE INVENTION

As an initial matter, in order to clearly describe the current disclosure it will become necessary to select certain terminology when referring to and describing relevant machine components within the scope of this disclosure. When doing this, if possible, common industry terminology will be used and employed in a manner consistent with its accepted meaning. Unless otherwise stated, such terminology should be given a broad interpretation consistent with the context of the present application and the scope of the appended claims. Those of ordinary skill in the art will appreciate that often a particular component may be referred to using several different or overlapping terms. What may be described herein as being a single part may include and be referenced in another context as consisting of multiple components. Alternatively, what may be described herein as including multiple components may be referred to elsewhere as a single part.

The following disclosure relates generally to additive manufacturing systems, and more particularly, to supports including conduits for removing material positioned within channels formed through components built on the supports using additive manufacturing systems and processes.

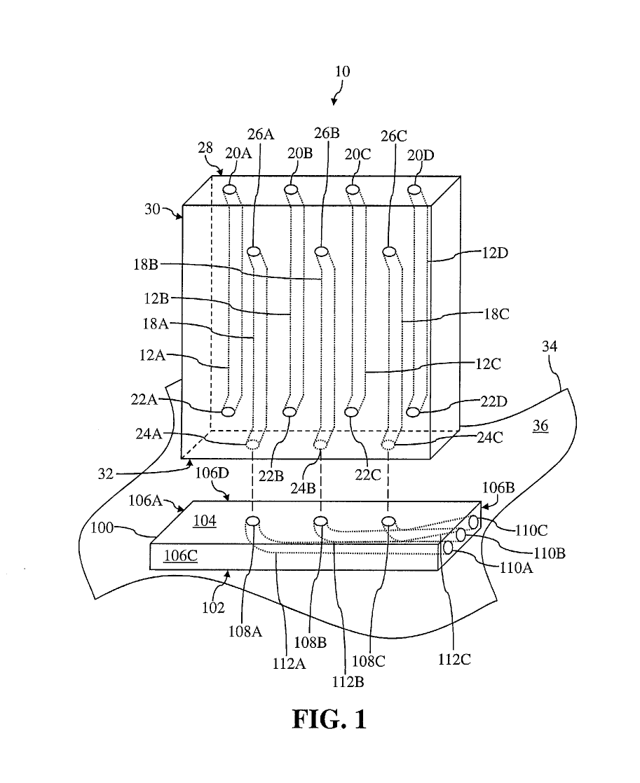

These and other embodiments are discussed below with reference to FIGS. 1-14. However, those skilled in the art will readily appreciate that the detailed description given herein with respect to these Figures is for explanatory purposes only and should not be construed as limiting.

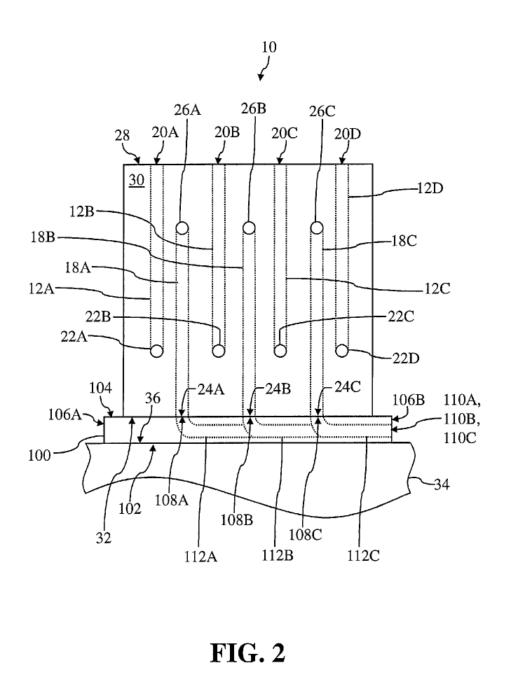

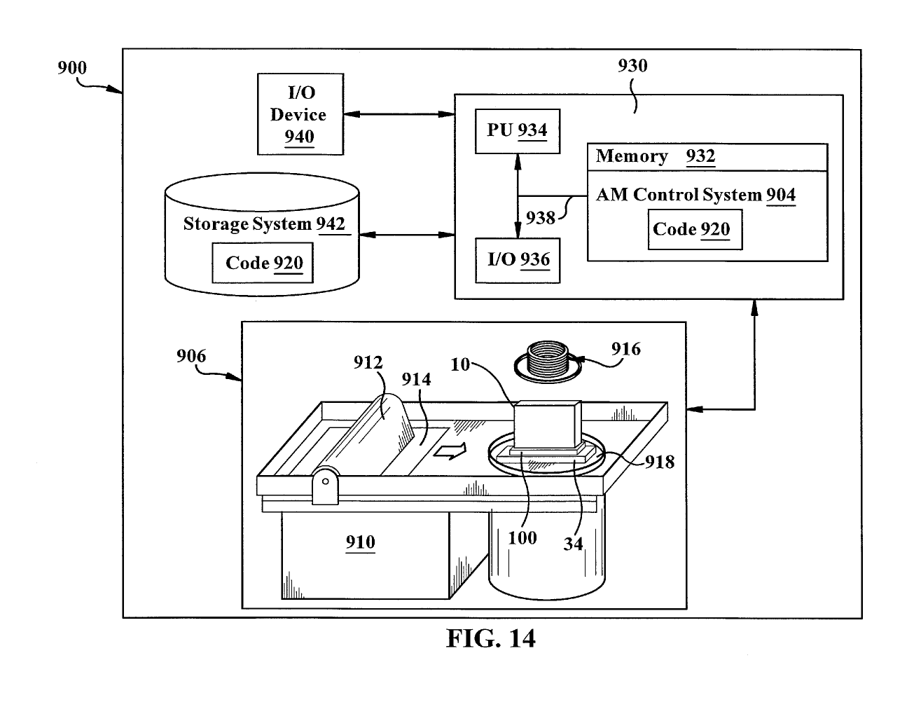

FIGS. 1 and 2 shows various views of a component 10 built on top of a support 100 of an additive manufacturing system (AMS) 900 (see, FIG. 14). Specifically, FIG. 1 shows an isometric, exploded view of component 10 built on top of support 100 of AMS, and FIG. 2 shows a front view of component 10 and support 100 of AMS. Component 10 may be formed by undergoing additive manufacturing process(es) using the AMS discussed herein. That is, component 100 may be built on support 100, and may include various features by utilizing the AMS to perform additive manufacturing process(es). As such, component 10 may be formed from any suitable material that may undergo the additive manufacturing process(es) performed by the AMS. In non-limiting examples, component 10 may be formed from thermoplastics, metals, metal-alloys, ceramics, glass and other suitable material.

In the non-limiting example shown in FIGS. 1 and 2, component 10 may include a first set of channels 12A, 12B, 12C, 12D and a second set of channels 18A, 18B, 18C, distinct from the first set of channels 12A, 12B, 12C, 12D. Each channel of the first set of channels 12A, 12B, 12C, 12D and the second set of channels 18A, 18B, 18C, respectively, may be formed through component 10 and may include apertures 20, 22, 24, 26 formed through two distinct surfaces of component 10. Specifically, and as shown in FIGS. 1 and 2, each channel of the first set of channels 12A, 12B, 12C, 12D may include and/or may be formed by aperture 20 formed through a top surface 28 of component 10, and aperture 22 formed through a front surface 30 of component 10, positioned adjacent and/or below top surface 28. Each channel of the first set of channels 12A, 12B, 12C, 12D may fluidly couple each aperture 20, 22 formed in component 10.

Additionally, each channel of the second set of channels 18A, 18B, 18C may include and/or may be formed by aperture 24 formed through a bottom surface 32 of component 10, and aperture 26 formed through front surface 30 of component 10. Bottom surface 32 of component 10 may be positioned below and/or opposite top surface 28, and adjacent front surface 30. Similar to the first set of channels 12A, 12B, 12C, 12D, each channel of the second set of channels 18A, 18B, 18C may fluidly couple each aperture 24, 26 formed in component 10. It is understood that the shape and/or geometry of the first set of channels 12A, 12B, 12C, 12D and the second set of channels 18A, 18B, 18C, respectively, shown herein is merely illustrative. As such, the first set of channels 12A, 12B, 12C, 12D and the second set of channels 18A, 18B, 18C may include any geometry and/or size that may correspond to an intended function and/or operation for component 10. Additionally, the number of channels of the first set of channels 12A, 12B, 12C, 12D and the second set of channels 18A, 18B, 18C of component 10 shown herein may also be merely illustrative, and component 10 may include more or less channels 12, 18 than those shown and discussed herein.

As discussed herein, component 10 may be built on support 100. Support 100 may be positioned on a build plate 34 of the AMS utilized to build component 10. Specifically, and as shown in FIGS. 1 and 2, build plate 34 may include a top surface 36 that may be exposed within the AMS, and bottom surface 102 of support 100 may be positioned directly on and/or contact top surface 36 of build plate 34. Build plate 34 may be formed as a solid component, from any suitable material used in additive manufacturing. In a non-limiting example, support 100, and the various features of support 100 discussed herein, may be built, created and/or manufactured separate from build plate 34 and support may be subsequently affixed, attached and/or coupled to top surface 36 of build plate 34. In this non-limiting example, support 100 may be coupled to top surface of build plate 34 by sintering, brazing, mechanical fastening, releasable coupling and/or any other suitable joining or coupling technique and/or coupling component. In another non-limiting example, the AMS (see, FIG. 14) utilizing build plate 34 and support 100 for building component 10 may build, create and/or additively manufacture support 100 directly on build plate 34. That is, the AMS may build support 100 directly on top surface 36 of build plate 34 prior to building component 10 on support 100, as discussed herein. AMS may build support 100 directly on build plate 34 by performing similar additive manufacturing process(es) that may form and/or build component 10.

Support 100 may be formed from any material capable of use in an additive manufacturing process. In one non-limiting example, support 100 may be formed from the same material as build plate 34 and/or component 10 to be formed thereon. In another non-limiting example, support 100 may be formed from a material different from the material used to form build plate 34 and/or component 10. In non-limiting examples, support 100 may be formed from metal, metal alloys, polymers, ceramics, composites and any other material having substantially similar physical properties.

Support 100 may include a build surface 104 positioned, formed and/or built opposite and above bottom surface 102. Build surface 104 of support 100 may be substantially exposed when support 100 is positioned on build plate 34. During an additive manufacturing process discussed herein, build surface 104 may receive, and/or be built upon by the AMS to form component 10. Support 100 may also include at least one side surface 106 positioned adjacent and/or below build surface 104. Additionally, side surface(s) 106 of support 100 may be positioned, formed and/or built between bottom surface 102 and build surface 104. In the non-limiting example shown in FIGS. 1 and 2, support 100 may be shaped and/or include a geometry of a quadrilateral, and specifically a rectangle. As a result, support 100 may include four distinct sides (e.g., first side 106A, second side 106B, third side 106C, fourth side 106D) formed between bottom surface 102 and build surface 104. It is understood that shape and/or geometry of support 100 shown herein is merely illustrative. As such, support 100 may include any geometry and/or size that may correspond to and/or may support the building of component 10 by the AMS, as discussed herein. As a result of the non-limiting possibilities for the shape and/or geometry of support 100, the number of sides 106 of support 100 shown herein may also be merely illustrative, and support 100 may include more or less sides 106 than those shown and discussed herein.

Support 100 may also include a plurality of openings. Specifically, and as shown in FIGS. 1 and 2, support 100 may include an outlet opening 108A, and an inlet opening 110A. Outlet opening 108A may be formed through and/or on build surface 104 of support 100. As shown in FIGS. 1 and 2, outlet opening 108A may also be configured to be or may be aligned with and/or in fluid communication with aperture 24A formed through and/or on bottom surface 32 of component 10 built above or on build surface 104. In the non-limiting example shown in FIGS. 1 and 2, inlet opening 110A may be formed on and/or through second side 106B of support 100. That is, inlet opening 110A may be formed through second side 106B, adjacent build surface 104 and/or outlet opening 108A.

As shown in FIGS. 1 and 2, support 100 may also include a conduit 112A. Conduit 112A may be formed within and/or through support 100, and may be substantially disposed between outlet opening 108A and inlet opening 110A. Conduit 112A may also be in fluid communication with each of outlet opening 108A and inlet opening 110A, respectively, and/or may fluidly couple outlet opening 108A and inlet opening 110A. As a result of conduit 112A fluidly coupling outlet opening 108A and inlet opening 110A, conduit 112A may form a passageway through support 100 and/or between build surface 104 and second side 106B. Additionally, and as a result of outlet opening 108A being aligned with and/or in fluid communication with aperture 24A of component 10, conduit 112A of support 100 and channel 18A of component 10 may be fluidly coupled and/or in fluid communication. As discussed herein, support 100, and specifically outlet opening 108A, inlet opening 110A and conduit 112A of support 100, may provide an open path or passageway to channel 18A of component 10 to allow a fluid (e.g., pressurized air) to flow through channel 18A. The fluid flowing through support 100, via conduit 112A, and through channel 18A may remove any unsintered material or particles that may undesirably remain in channel 18A after the formation of component 10 on build surface 104 of support 100.

Support 100 may also include at least one distinct outlet opening 108B, 108C. The number of outlet openings 108A, 108B, 108C formed in support 100 may be dependent, at least in part, on the number of channels in the second set of channels 18A, 18B, 18C formed through component 10. That is, support 100 may, for example, include as many outlet openings 108A, 108B, 108C as there are channels forming the second set of channels 18A, 18B, 18C. As such, in the non-limiting example shown in FIGS. 1 and 2, support 100 may include three distinct outlet openings 108A, 108B, 108C, where each outlet opening may correspond to one of the three channels of the second set of channels 18A, 18B, 18C formed through component 10 (e.g., outlet opening 108A—channel 18A, outlet opening 108B—channel 18B and so on). It is understood that the number of outlet openings 108A, 108B, 108C of support 100 shown herein may be merely illustrative. As such, support 100 may include more or less outlet openings 108A, 108B, 108C than those shown and discussed herein. Additionally in other non-limiting examples, support 100 may include more or less outlet openings 108A, 108B, 108C than the number of channels forming the second set of channels 18A, 18B, 18C.

Similar to outlet opening 108A, each of the distinct outlet openings 108B, 108C may be formed through and/or on build surface 104 of support 100. As shown in FIGS. 1 and 2, distinct outlet openings 108B, 108C may also be configured to be or may be aligned with and/or in fluid communication with respective apertures 24B, 24C formed through and/or on bottom surface 32 of component 10 built above or on build surface 104. That is, outlet opening 108B may be aligned with and/or in fluid communication with aperture 24B formed through bottom surface 32 of component 10, and outlet opening 108C may be aligned with and/or in fluid communication with aperture 24C formed through bottom surface 32 of component 10.

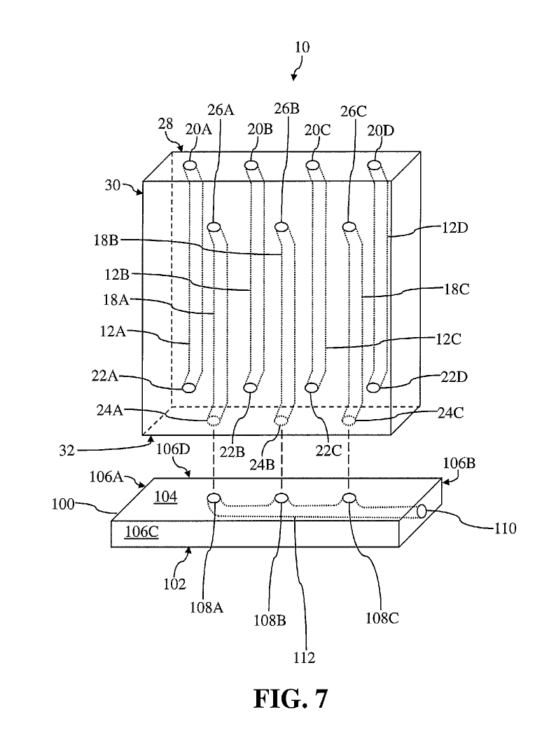

In the non-limiting example shown in FIGS. 1 and 2, support 100 may also include at least one distinct inlet opening 110B, 110C. Distinct inlet openings 110B, 110C may be formed on and/or through second side 106B of support 100, adjacent inlet opening 110A. That is, distinct inlet openings 110B, 110C may be formed through second side 106B similar to inlet opening 110A, and may be formed adjacent build surface 104 and/or outlet openings 108A, 108B, 108C. In the non-limiting example, the number of inlet openings 110A, 110B, 110C formed in support 100 may be dependent, at least in part, on the number of outlet openings 108A, 108B, 108C formed through support 100. That is, support 100 may, for example, include as many inlet openings 110A, 110B, 110C as outlet openings 108A, 108B, 108C. As such, in the non-limiting example shown in FIGS. 1 and 2, support 100 may include three distinct outlet openings 108A, 108B, 108C and inlet openings 110A, 110B, 110C, where each inlet opening may correspond to one of the three outlet openings 108A, 108B, 108C (e.g., outlet opening 108A—inlet opening 110A, outlet opening 108B—inlet opening 110B and so on). It is understood that the number of outlet openings 108A, 108B, 108C of support 100 shown herein may be merely illustrative. As such, support 100 may include more or less inlet openings 110A, 110B, 110C than those shown and discussed herein. Additionally, and in other non-limiting examples discussed herein (see, FIG. 7), the number of inlet openings 110A, 110B, 110C may be independent from and/or different from the number of outlet openings 108A, 108B, 108C formed within support 100.

As a result of support 100 including a plurality of outlet openings 108A, 108B, 108C, and inlet openings 110A, 110B, 110C, support 100 may also include at least one distinct conduit 112B, 112C. That is, support 100 may include a number of conduits 112A, 112B, 112C that may dependent, at least in part, on and/or may be equal to the number of outlet openings 108A, 108B, 108C and inlet openings 110A, 110B, 110C formed through support 100. As such, in the non-limiting example shown in FIGS. 1 and 2, support 100 may include three distinct conduits 112A, 112B, 112C that may correspond to and, may be in fluid communication with and/or fluidly couple a single, corresponding outlet opening 108A, 108B, 108C and single, corresponding inlet openings 110A, 110B, 110C, respectively. For example, and as shown in FIGS. 1 and 2, distinct conduit 112B may fluidly couple outlet opening 108B and inlet opening 110B, and distinct conduit 112C may fluidly couple outlet opening 108C and inlet opening 110C. Similar to conduit 112A, distinct conduits 112B, 112C may be formed within and/or through support 100, and may be substantially disposed between corresponding outlet openings 108B, 108C and inlet openings 110B, 110C. As a result of distinct conduits 112B, 112C fluidly coupling corresponding outlet openings 108B, 108C and inlet openings 110B, 110C, conduits 112B, 112C may form a passageway through support 100 and/or between build surface 104 and second side 106B. Additionally, and as a result of outlet openings 108B, 108C being aligned with and/or in fluid communication with corresponding apertures 24B, 24C of component 10, distinct conduits 112B, 112C of support 100 and corresponding channels 18B, 18C of component 10 may be fluidly coupled and/or in fluid communication. It is understood that the number of conduits 112A, 112B, 112C of support 100 shown herein may be merely illustrative. As such, support 100 may include more or less conduits 112A, 112B, 112C than those shown and discussed herein. Additionally, and in other non-limiting examples discussed herein (see, FIG. 7), the number of conduits may be independent from and/or different from the number of corresponding outlet openings 108A, 108B, 108C and/or inlet openings 110A, 110B, 110C formed within support 100.

As discussed herein, support 100, and specifically outlet openings 108A, 108B, 108C, inlet openings 110A, 110B, 110C and conduits 112A, 112B, 112C of support 100, may provide an open path or passageway to the second set of channels 18A, 18B, 18C of component 10. That is, the formation of outlet openings 108A, 108B, 108C, inlet openings 110A, 110B, 110C and conduits 112A, 112B, 112C of support 100 may form the passageway between and/or may allow conduits 112A, 112B, 112C to be fluidly coupled with the second set of channels 18A, 18B, 18C of component 10. In turn, the second set of channels 18A, 18B, 18C, like the first set of channels 12A, 12B, 12C having exposed apertures 20, 22 formed therein, may include exposed apertures 24, 26 that may not be blocked, obstructed and/or accessible after the building process performed by the AMS (see, FIG. 14). Specifically, and as shown in FIGS. 1 and 2, support 100 include outlet openings 108A, 108B, 108C, inlet openings 110A, 110B, 110C and conduits 112A, 112B, 112C may not block, obstruct and/or may provide fluid access to aperture 24A, 24B, 24C, and in turn the second set of channels 18A, 18B, 18C.

As a result, support 100 include outlet openings 108A, 108B, 108C, inlet openings 110A, 110B, 110C and conduits 112A, 112B, 112C may allow a fluid (e.g., pressurized air) to flow through the second set of channels 18A, 18B, 18C to remove any unsintered material and/or particles that may undesirably remain in channels 18A, 18B, 18C after the formation of component 10 on build surface 104 of support 100. In a non-limiting example, the fluid utilized to remove unsintered material and/or particles from the second set of channels 18A, 18B, 18C may flow through support 100 and component 10, respectively in the following sequential order: inlet openings 110A, 110B, 110C, conduits 112A, 112B, 112C, outlet openings 108A, 108B, 108C, aperture 24A, 24B, 24C, the second set of channels 18A, 18B, 18C, apertures 26A, 26B, 26C. In another non-limiting example, the fluid may flow through support 100 and component 10, respectively in the following order: apertures 26A, 26B, 26C, the second set of channels 18A, 18B, 18C, aperture 24A, 24B, 24C, outlet openings 108A, 108B, 108C, conduits 112A, 112B, 112C, inlet openings 110A, 110B, 110C. It is understood that all channels of the second set of channels 18A, 18B, 18C may be exposed to the fluid at one time. Alternatively, only a portion, or one channel, of the second set of channels 18A, 18B, 18C may be exposed to the fluid at a time to remove any unsintered material and/or particles that may undesirably remain in channels 18A, 18B, 18C after the formation of component 10, as discussed herein.

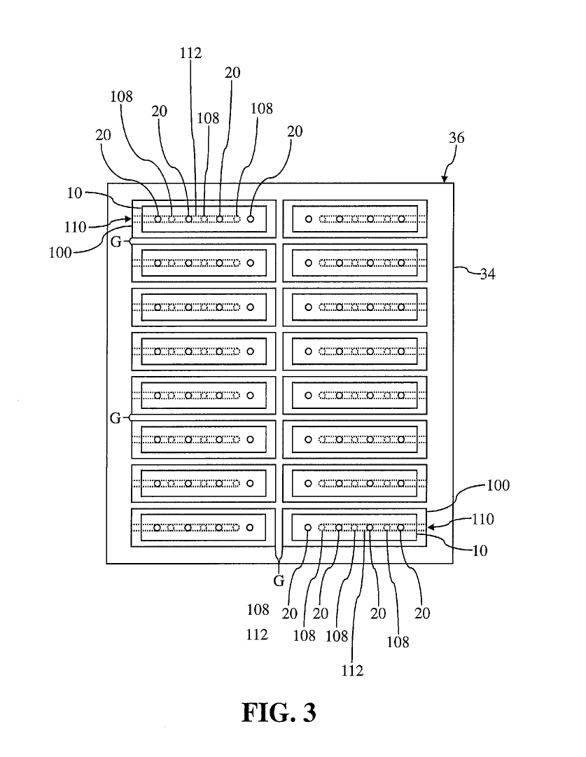

FIG. 3 shows a top view of build plate 34 of the AMS (see, FIG. 14) including a plurality of supports 100 and a plurality of components 10. The first set of channels 12A, 12B, 12C, 12D and the second set of channels 18A, 18B, 18C, and other portions of components 10 may be omitted from FIG. 3 for clarity. As shown in FIG. 3, each of the plurality of supports 100 may be positioned directly on top surface 36 of build plate 34. Specifically, and as discussed herein, each of the plurality of supports 100 may be coupled directly to top surface 36 of build plate 34, or alternatively, may be built directly on top surface 36 of build plate 34 using the AMS. Additionally, and as shown in FIG. 3, each of the plurality of supports 100 may be positioned directly adjacent one another and may be separated by a gap (G). The gap (G) separating each of the plurality of supports 100 may be a predetermined distance that dependent from the size, shape and/or geometry of components 10 being built on each of the plurality of supports 100. As such, the predetermined distance for the gap (G) formed between each support 100 may ensure that component 10 built on one support 100 may not contact and/or interfere with the building of a distinct component 10 formed on a distinct, adjacent support 100. Additionally, the predetermined distance for the gap (G) may also maximize the number of supports 100, and ultimately the number of components 10, that may be included on build plate 34 of the AMS. In a non-limiting example, the predetermined distance for the gap (G) may be minimal and/or may be within a range of approximately 0.5 millimeters (mm) to approximately 50 mm.

As a result of the predetermined distance for the gap (G) being minimal (e.g., 5 mm to 50 mm), portions of component 10 built on supports 100 may not be accessible. For example, front surface 30 and apertures 22, 26 formed through front surface 30 of component 10 (see, FIGS. 1 and 2) may not be accessible to a user who may perform processes for providing fluid through the second set of channels 18 to remove unsintered material and/or particles. As such, the fluid provided to remove unsintered material and/or particles may only be provided to the second set of channels 18 through support 100, and specifically, inlet opening 110, conduit 112 and outlet opening 108, as discussed herein. In the non-limiting example shown in FIG. 3, where build plate 34 includes a plurality of supports 100 separated by a minimal gap (G), each inlet opening 110 formed through each of the plurality of supports 100 may be substantially exposed, formed on the outside of support 100 and/or may be positioned adjacent a “perimeter” of the collective shape formed by the plurality of supports 100 positioned on build plate 34.

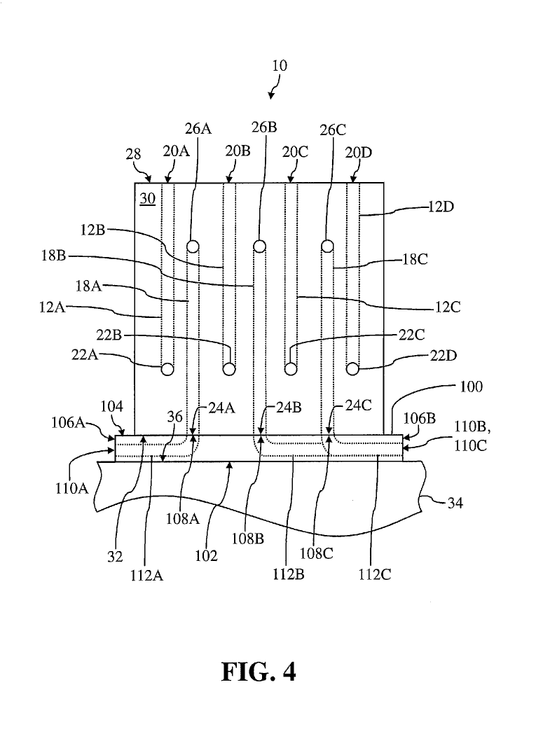

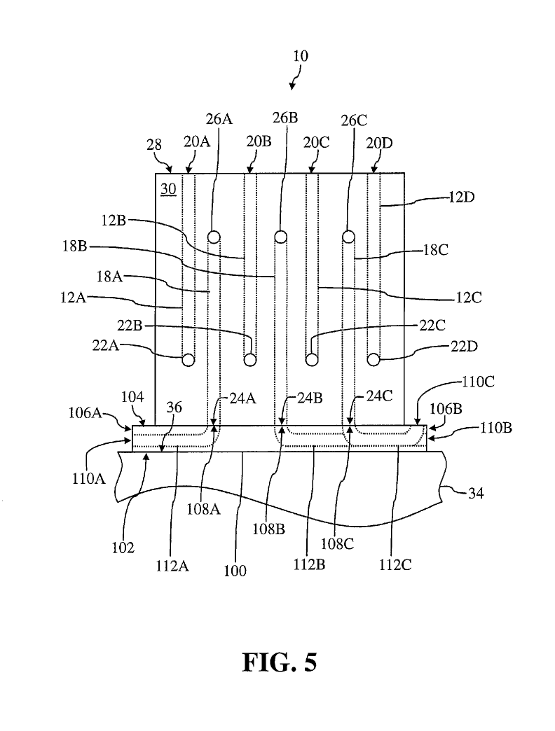

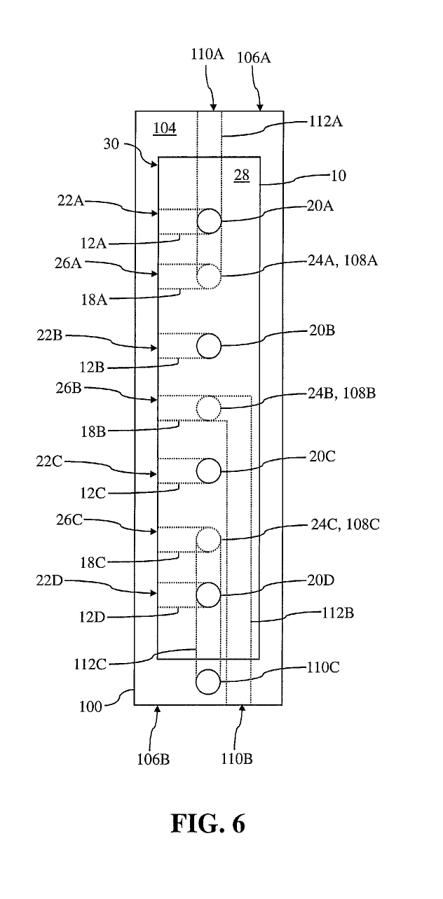

FIGS. 4-7 shows additional, non-limiting examples of support 100 utilized by the AMS (see, FIG. 14) for building component 10. Specifically, FIG. 4 shows a front view of component 10 and support 100 including inlet opening(s) 110A, 110B, 110C formed on distinct sides of support 100. FIGS. 5 and 6 show a front and top view, respectively, of component 10 and support 100 including inlet opening(s) 110A, 110B, 110C formed on distinct sides and/or build surface 104 of support 100. FIG. 7 shows an isometric exploded view of component 10 and support 100 including a single inlet opening 110 and single conduit 112. It is understood that similarly numbered and/or named components may function in a substantially similar fashion. Redundant explanation of these components has been omitted for clarity.

Turning to FIG. 4, and with comparison to FIGS. 1 and 2, inlet openings 110A, 110B, 110C may be formed on distinct sides 106A, 106B of support 100. That is, inlet openings 110B, 110C may be formed through side 106B of support 100 and conduits 112B, 112C may extend from side 106B and/or between inlet openings 110B, 110C and outlet openings 108B, 108C, respectively, as similarly discussed herein with respect to FIGS. 1 and 2. However, in the non-limiting example shown in FIG. 4, inlet opening 110A may be formed through side 106A of support 100, distinct from and/or opposite to side 106B. As a result, conduit 112A may extend from side 106A and/or may be formed between inlet opening 110A and outlet opening 108A, opposite, separated from and/or adjacent conduits 112B, 112C of support 100.

In the non-limiting example shown in FIGS. 5 and 6, inlet opening(s) 110 may be formed on distinct sides 106A, 106B and/or build surface 104 of support 100. As shown in FIGS. 5 and 6, and as similarly discussed herein with respect to FIG. 4, inlet opening 110A may be formed through side 106A of support 100 and conduit 112A may extend from side 106A and/or between inlet opening 110A and outlet opening 108A. Additionally, and as similarly discussed herein with respect to FIGS. 1, 2 and 4, inlet opening 110B may be formed through side 106B of support 100 and conduit 112B may extend from side 106B and/or between inlet opening 110B and outlet opening 108B. Distinct from the non-limiting examples discussed herein, the non-limiting example shown in FIGS. 5 and 6 includes inlet opening 110C formed through and/or positioned on build surface 104 of support 100. Specifically, inlet opening 110C formed through build surface 104 of support 100, and may be positioned adjacent and/or above inlet opening 110A formed through side 106A and inlet opening 110B formed through side 106B, respectively. As shown in FIGS. 5 and 6, conduit 112C may extend from build surface 104 of support 100 and/or may extend between inlet opening 110C and outlet opening 108C.

In the non-limiting example shown in FIG. 7, support 100 may include a single inlet opening 110. That is, and distinct from the non-limiting examples discussed and shown herein, support 100 depicted in FIG. 7 may include a plurality of distinct outlet openings 108A, 108B, 108C, but only a single inlet opening 110 formed through side 106B. As a result of including a single inlet opening 110, support 100 may also include a single conduit, manifold or plenum 112 (hereafter, “conduit 112”). Conduit 112 of support 100 may fluidly couple single inlet opening 110 to each of the plurality of distinct outlet openings 108A, 108B, 108C. When providing fluid through support via inlet opening 110 to remove unsintered material and/or particles from the second set of channels 18A, 18B, 18C, conduit 112 may provide the fluid to each outlet opening 108A, 108B, 108C simultaneously.

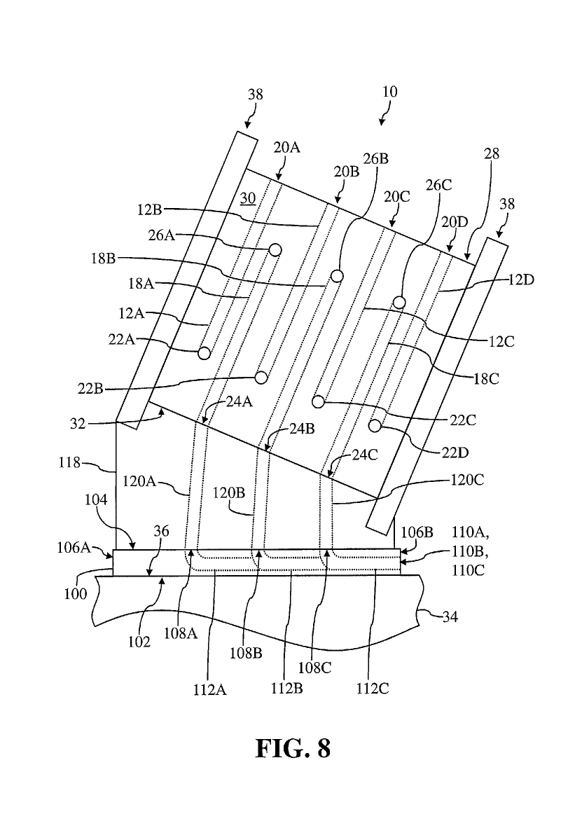

FIG. 8 shows a front view of component 10 including features 38, and support 100. In the non-limiting example shown in FIG. 8, and with comparison to FIGS. 1 and 2, features 38 of component 10 may be additional structures and/or build portions that may require component 10 to be built at an angle. Specifically, the features 38 of component 10 may require component 10 to be built at an angle and/or built on or braced by at least one joist 118 formed, positioned and/or built on build surface 104 of support 100. Joist 118 may be shaped and/or configured to support component 10 including features 38, and/or allow the AMS (see, FIG. 14) to build component 10 including features 38.

In the non-limiting example, joist 118 may also include at least one passage 120A, 120B, 120C formed completely through joist 118 and/or between support 100 and component 10. The number of passages 120A, 120B, 120C formed in joist 118 may be dependent, at least in part, on the number of outlet openings 108A, 108B, 108C formed through support 100 and/or the number of channels included within the second set of channels 18A, 18B, 18C formed in component 10. That is, joist 118 may, for example, include as many passages 120A, 120B, 120C as outlet openings 108A, 108B, 108C and/or channels in the second set of channels 18A, 18B, 18C. As such, in the non-limiting example shown in FIG. 8, joist 118 may include three distinct passages 120A, 120B, 120C, where each passage 120A, 120B, 120C may correspond to one of the three outlet openings 108A, 108B, 108C and/or channels of the second set of channels 18A, 18B, 18C. It is understood that the number of passages 120A, 120B, 120C of joist 118 shown herein may be merely illustrative, and in some embodiments may be independent from and/or different than the number of outlet openings 108A, 108B, 108C and/or channels in the second set of channels 18A, 18B, 18C. As such, joist 118 may include more or less passages 120A, 120B, 120C than those shown and discussed herein.

As shown in FIG. 8, where the AMS utilizes joist 118 on support 100 when building component 10 including the second set of channels 18A, 18B, 18C, each passage 120A, 120B, 120C of joist 118 may be aligned with and/or be in fluid communication with a corresponding channel of the second set of channels 18A, 18B, 18C. Additionally in the non-limiting example, each passage 120A, 120B, 120C of joist 118 may be aligned with and/or be in fluid communication with a corresponding outlet opening 108A, 108B, 108C, inlet opening 110A, 110B, 110C and/or conduit 112A, 112B, 112C. As a result, each passage 120A, 120B, 120C of joist 118 may fluidly couple the corresponding outlet opening 108A, 108B, 108C formed through build surface 104 of support 100 and the corresponding aperture 24A, 24B, 24C formed through bottom surface 32 of component 10. When providing fluid to support 100 to remove unsintered material and/or particles from the second set of channels 18A, 18B, 18C of component 10, the fluid may pass through passages 120A, 120B, 120C prior to flowing through the second set of channels 18A, 18B, 18C of component 10, as discussed herein.

Joist 118, and the passages 120A, 120B, 120C of joist 118, may be built, created and/or manufactured separate from support 100 and joist 118 may be subsequently affixed, attached and/or coupled to build surface 104 of support 100. In this non-limiting example, joist 118 may be coupled to build surface 104 of support 100 by any suitable joining or coupling technique and/or coupling component. In another non-limiting example, the AMS (see, FIG. 14) may build, create and/or additively manufacture joist 118 directly on build surface 104 of support 100 by performing similar additive manufacturing process(es) that may form and/or build support 100 and/or component 10. Joist 118 may be formed from any material capable of use in an additive manufacturing process. In one non-limiting example, joist 118 may be formed from the same material as build plate 34, component 10 and/or support 100. In another non-limiting example, joist 118 may be formed from a material different from the material used to form build plate 34, component 10 and/or support 100. In non-limiting examples, joist 118 may be formed from metal, metal alloys, polymers, ceramics, composites and any other material having substantially similar physical properties.

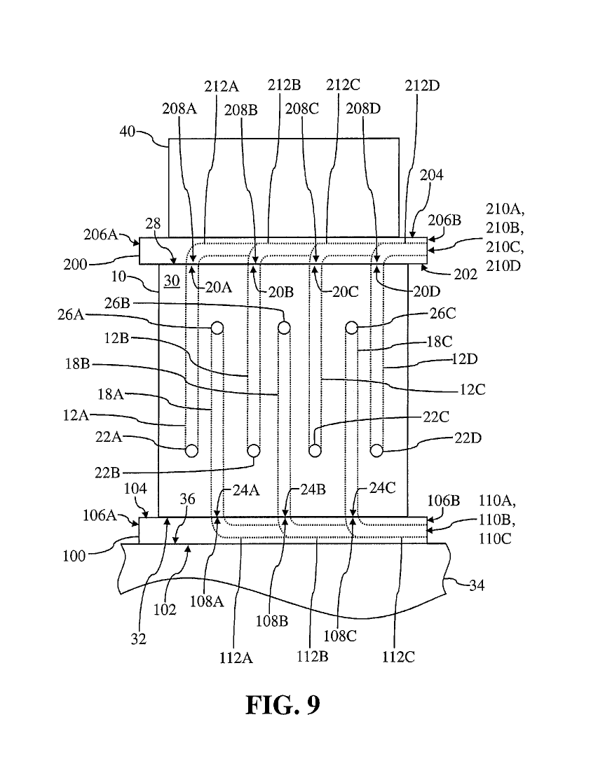

FIGS. 9-13 show front views of component 10 formed on support 100, and a distinct component 40 formed on a distinct support 200, according to various non-limiting examples. In the non-limiting examples shown in FIGS. 9-13, it is understood that component 10 and distinct component 40 may be sized and/or include a geometry that may allow for distinct support 200 to be positioned and/or build on component 10, and distinct component 40 may be subsequently built on distinct support 200. Component 10 and support 100 may be substantially similar to the component and support discussed and shown herein with respect to FIGS. 1 and 2. Redundant explanation of these components has been omitted for clarity.

Turning to the non-limiting example shown in FIG. 9, support 200 may be positioned on, above, coupled to and/or built directly on top surface 28 of component 10. Specifically, bottom surface 202 of support 200 may be positioned on and/or may contact top surface 28 of component 10. Where, support 200 is larger than component 10, as shown in FIG. 9, the AMS (see, FIG. 14) building component 10, support 100, distinct support 200 and/or distinct component 40 may also build and/or utilize structure material (not shown) that may be positioned on either side of component 10 and below distinct support 200 for bracing distinct support 200. Once positioned above and/or build directly on top surface 28 of component 10, distinct component 40 may be formed and/or built directly on distinct support 200 in a similar manner as discussed herein with respect to component 10 being built on support 100 (see, FIGS. 1 and 2). In the non-limiting example shown in FIG. 9, distinct component 40 may be a solid component that may not include channels like those included in component 10. As a result, distinct support 200 may not include outlet openings, inlet openings and/or conduits that utilized to provide fluid through distinct component 40.

However, because distinct support 200 is positioned directly on top surface 28 and/or above component 10 including apertures 20A, 20B, 20C, 20D and corresponding first set of channels 12A, 12B, 12C, 12D, support 200 may include outlet openings 208A, 208B, 208C, 208D, inlet openings 210A, 210B, 210C, 210D and conduits 212A, 212B, 212C, 212D. Specifically, support 200 may include outlet openings 208A, 208B, 208C, 208D, inlet openings 210A, 210B, 210C, 210D and conduits 212A, 212B, 212C, 212D to provide a passageway to the first set of channels 12A, 12B, 12C, 12D of component 10 that may otherwise be blocked and/or obstructed by distinct support 200. As shown in FIG. 9, outlet openings 208A, 208B, 208C, 208D may be formed through and/or positioned on bottom surface 202 of distinct support 200, and each outlet opening 208A, 208B, 208C, 208D may be substantially aligned with and/or in fluid communication with a corresponding aperture 20A, 20B, 20C, 20D formed through top surface 28 of component 10. Inlet openings 210A, 210B, 210C, 210D may be formed through side 206B of support 200 and conduits 212A, 212B, 212C, 212D may extend from side 206B and/or between inlet openings 210A, 210B, 210C, 210D and outlet openings 208A, 208B, 208C, 208D. As similarly discussed herein with respect to support 100 and the second set of channels 18A, 18B, 18C, 18D depicted in FIGS. 1 and 2, the various features formed within distinct support 200 (e.g., outlet openings 208, inlet openings 210, conduits 212) may provide an open path or passageway to each channel of the first set of channels 44A, 44B, 44C, 44D of component 40. As such, support 200 and its various features may allow a fluid (e.g., pressurized air) to flow through the first set of channels 44A, 44B, 44C, 44D to remove any unsintered material or particles that may undesirably remain in the first set of channels 44A, 44B, 44C, 44D after the formation of distinct component 40 on distinct support 200.

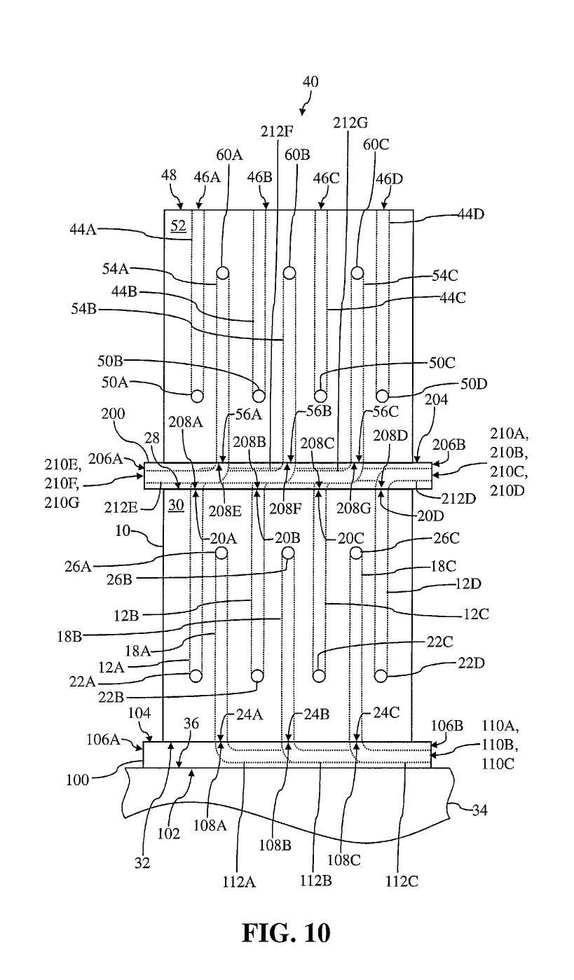

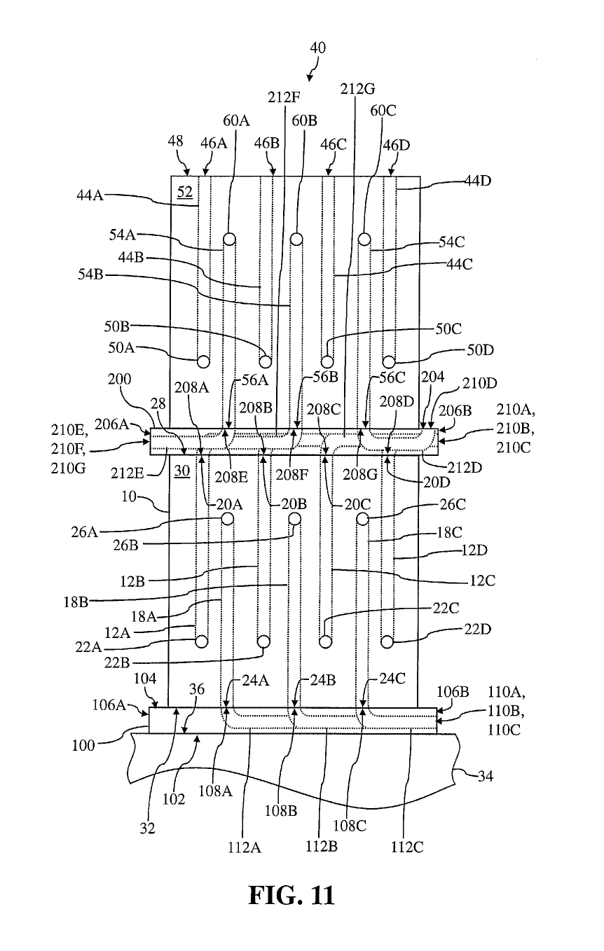

In the non-limiting examples shown in FIGS. 10 and 11, support 200 may include outlet openings 208A, 208B, 208C, 208D, inlet openings 210A, 210B, 210C, 210D and conduits 212A (not shown), 212B (not shown), 212C (not shown), 212D, as previously discussed herein with respect to FIG. 9. Additionally as shown in FIGS. 10 and 11, distinct component 40 may be substantially similar to and/or may include similar features as component 10. That is, distinct component 40 formed and/or built on distinct support 200 may include a first set of channels 44A, 44B, 44C, 44D extending between apertures 46A, 46B, 46C, 46D formed in a top surface 48 and apertures 50A, 50B, 50C, 50D formed in a front surface 52. Additionally, distinct component 40 may include a second set of channels 54A, 54B, 54C extending between apertures 56A, 56B, 56C formed in a bottom surface 58 and apertures 60A, 60B, 60C formed in front surface 52.

As a result of distinct component 40 including similar features as component 10 (e.g., first set of channels 44A, 44B, 44C, 44D, second set of channels 54A, 54B, 54C), support 200 may include additional features. Specifically, distinct support 200 may also include outlet openings 208E, 208F, 208G formed through and/or positioned on build surface 204 of distinct support 200. Each outlet opening 208E, 208F, 208G may be substantially aligned with and/or in fluid communication with a corresponding aperture 56A, 56B, 56C formed through bottom surface 58 of distinct component 40. Additionally as shown in FIGS. 10 and 11, distinct support 200 may include inlet openings 210E, 210F, 210G formed in distinct support 200 and conduits 212E, 212F, 212G extending between inlet openings 210E, 210F, 210G and outlet openings 208E, 208F, 208G. In the non-limiting example shown in FIG. 10, inlet openings 210E, 210F, 210G may be formed through and/or positioned on side 206A, opposite side 206B and/or inlet openings 210A, 210B, 210C, 210D. In another non-limiting example shown in FIG. 11, inlet opening 210G may be formed through and/or positioned on build surface side 204, adjacent and/or above sides 206A, 206B of distinct support 200. It is understood that inlet openings 210A, 210B, 210C, 210D, 210E, 210F, 210G of distinct support 200 may be formed on any or all sides and/or surfaces of distinct support 200.

As similarly discussed herein with respect to support 100 and the second set of channels 18A, 18B, 18C, 18D depicted in FIGS. 1 and 2, the various features formed within support 200 (e.g., outlet openings 208, inlet openings 210, conduits 212) may provide an open path or passageway to each channel of the second set of channels 54A, 54B, 54C of component 40. As such, support 200 and its various features may allow a fluid (e.g., pressurized air) to flow through the second set of channels 54A, 54B, 54C to remove any unsintered material or particles that may undesirably remain in the second set of channels 54A, 54B, 54C after the formation of distinct component 40 on distinct support 200.

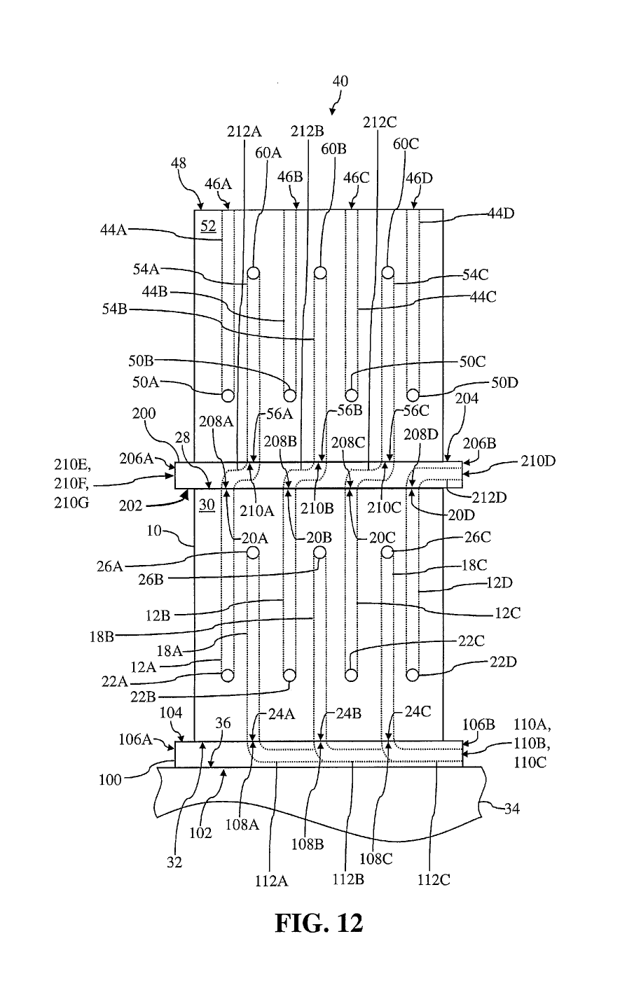

FIG. 12 shows another non-limiting example of distinct support 200. Similarly discussed herein with respect to FIGS. 9-11, distinct support 200 may include outlet opening 208D formed through bottom surface 202 of distinct support 200, inlet opening 210D formed through side surface 206B and conduit 212D fluidly coupling outlet opening 208D and inlet opening 210D. Outlet opening 208D, inlet opening 210D and conduit 212D of distinct support 200 may be in fluid communication with channel 12D formed through component 10. In the non-limiting example shown in FIG. 12, distinct support 200 may also include a plurality of outlet openings 208A, 208B, 208C, inlet openings 210A, 210B, 210C, and conduits 212A, 212B, 212C. As shown in FIG. 12 outlet openings 208A, 208B, 208C may be formed through and/or positioned on bottom surface 202 of distinct support 200, and inlet openings 210A, 210B, 210C may be formed through and/or positioned on build surface 204 of distinct support 200. Conduits 212A, 212B, 212C, may extend between and/or may fluidly couple corresponding outlet openings 208A, 208B, 208C and inlet openings 210A, 210B, 210C. As shown in the non-limiting example of FIG. 12, outlet openings 208A, 208B, 208C, inlet openings 210A, 210B, 210C, and conduits 212A, 212B, 212C of distinct support 200 may fluidly couple channels 12A, 12B, 12C of the first set of channel 12A, 12B, 12C, 12D formed in component 10 with a corresponding channel of the second set of channels 54A, 54B, 54C formed in distinct component 40.

As a result, distinct support 200 shown in FIG. 12 (e.g., outlet openings 208, inlet openings 210, conduits 212) may provide an open path or passageway to channels 12A, 12B, 12C of the first set of channels 12A, 12B, 12C, 12D of component 10, and the second set of channels 54A, 54B, 54C formed in distinct component 40. As such, distinct support 200 and its various features may allow a fluid (e.g., pressurized air) to flow through the channels 12A, 12B, 12C of component 10, and the second set of channels 54A, 54B, 54C of distinct component 40, respectively to remove any unsintered material or particles that may undesirably remain in the channels 12A, 12B, 12C of component 10, and the second set of channels 54A, 54B, 54C of distinct component 40. In a non-limiting example, the fluid may be initially applied through apertures 60A, 60B, 60C formed in distinct component 40, and may flow through the second set of channels 54A, 54B, 54C, distinct support 200, channels 12A, 12B, 12C of the first set of channels 12A, 12B, 12C, 12D of component 10, and may exit through apertures 22A, 22B, 22C formed through component 10.

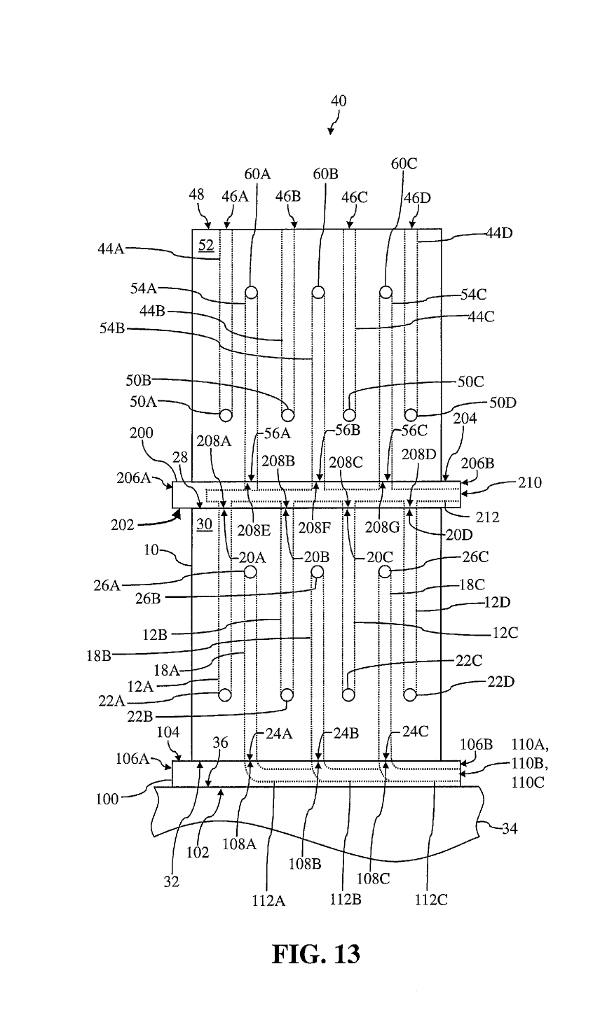

FIG. 13 shows another non-limiting example of distinct support 200. Similar to support 100 shown and discussed herein with respect to FIG. 7, distinct support 200 may include a plurality of outlet openings 208A, 208B, 208C, 208D, 208E, 208F, 208G, but only a single inlet opening 210, and a single conduit 212. As shown in FIG. 13, and similarly discussed herein, outlet openings 208A, 208B, 208C, 208D may be formed through bottom surface 202 of distinct support 200 and may be in fluid communication and/or fluidly coupled with corresponding channels of the first set of channels 12A, 12B, 12C, 12D formed in component 10. Additionally, outlet openings 208E, 208F, 208G may be formed through build surface 204 of distinct support 200 and may be in fluid communication and/or fluidly coupled with corresponding channels of the second set of channels 54A, 54B, 54C formed in distinct component 40. As shown in FIG. 13, inlet opening 210 of distinct support 200 may be formed through side 206B, and conduit 212 may fluidly couple single inlet opening 210 to each of the plurality of distinct outlet openings 208A, 208B, 208C, 208D, 208E, 208F, 208G. As similarly discussed herein with reference to support 100 shown in FIG. 7, when providing fluid through distinct support 200 via inlet opening 210, conduit 212 may provide the fluid to each outlet opening 208A, 208B, 208C, 208D, 208E, 208F, 208G simultaneously.

FIG. 14 shows a schematic/block view of an illustrative computerized additive manufacturing system 900 for generating support 100 on build plate 34 or build platform 918 and/or component 10 on support 100. In this example, system 900 is arranged for direct metal laser melting (DMLM), a metal powder additive manufacturing process. It is understood that the general teachings of the disclosure are equally applicable to other forms of additive manufacturing. Support 100 is illustrated as a support element for component 10; however, it is understood that the additive manufacturing process can be readily adapted to manufacture any support for any component. AM system 900 generally includes a computerized additive manufacturing (AM) control system 904 and an AM printer 906. AM system 900, as will be described, executes code 920 that includes a set of computer-executable instructions defining support 100 and/or component 10 to physically generate support 100 using AM printer 906. Each AM process may use different raw materials in the form of, for example, fine-grain metal powder, a stock of which may be held in a chamber 910 of AM printer 906. In the instant case, support 100 may be made of metal or a metal alloy. As illustrated, an applicator 912 may create a thin layer of raw material 914 spread out as the blank canvas from which each successive slice of the final component or support 100 will be created. In the example shown, a laser or electron beam 916, positioned above build platform 918, build plate 34 and/or support 100, fuses particles for each slice, as defined by code 920. Although one laser or electron beam 916 is shown, it is understood that AM system 900 may include more. Various parts of AM printer 906 may move to accommodate the addition of each new layer, e.g., a build platform 918 may lower and/or chamber 910 and/or applicator 912 may rise after each layer. In this example, build plate 34 including support 100 is distinct from and/or positioned on or above build platform 918. It is understood that build plate 34 is not limited to the example of FIG. 1, and build platform 918 may in one example act as build plate 34 for building support 100 and/or component 10.

AM control system 904 is shown implemented on computer 930 as computer program code. To this extent, computer 930 is shown including a memory 932, a processor 934, an input/output (I/O) interface 936, and a bus 938. Further, computer 930 is shown in communication with an external I/O device/resource 940 and a storage system 942. In general, processor 934 executes computer program code, such as AM control system 904 that may be stored in memory 932 and/or storage system 942 under instructions from code 920 representative of support 100 and/or component 10. While executing computer program code, processor 934 can read and/or write data to/from memory 932, storage system 942, I/O device 940 and/or AM printer 906. Bus 938 provides a communication link between each of the components in computer 930, and I/O device 940 can comprise any device that enables a user to interact with computer 940 (e.g., keyboard, pointing device, display, etc.). Computer 930 is only representative of various possible combinations of hardware and software. For example, processor 934 may comprise a single processing unit, or be distributed across one or more processing units in one or more locations, e.g., on a client and server. Similarly, memory 932 and/or storage system 942 may reside at one or more physical locations. Memory 932 and/or storage system 942 can comprise any combination of various types of non-transitory computer readable storage medium including magnetic media, optical media, random access memory (RAM), read only memory (ROM), etc. Computer 930 can comprise any type of computing device such as a network server, a desktop computer, a laptop, a handheld device, a mobile phone, a pager, a personal data assistant, etc.

Additive manufacturing processes begin with a non-transitory computer readable storage medium (e.g., memory 932, storage system 942, etc.) storing code 920 representative of support 100. As noted, code 920 includes a set of computer-executable instructions defining support 100 and/or component 10 that can be used to physically generate support 100, upon execution of the code by system 900. For example, code 920 may include a precisely defined 3D model of support 100 and/or component 10 and can be generated from any of a large variety of well-known computer aided design (CAD) software systems such as AutoCAD®, TurboCAD®, DesignCAD 3D Max, etc. In this regard, code 920 can take any now known or later developed file format. For example, code 920 may be in the Standard Tessellation Language (STL) which was created for stereolithography CAD programs of 3D Systems, or an additive manufacturing file (AMF), which is an American Society of Mechanical Engineers (ASME) standard that is an extensible markup-language (XML) based format designed to allow any CAD software to describe the shape and composition of any three-dimensional component to be fabricated on any AM printer. Code 920 may be translated between different formats, converted into a set of data signals and transmitted, received as a set of data signals and converted to code, stored, etc., as necessary. Code 920 may be an input to system 900 and may come from a part designer, an intellectual property (IP) provider, a design company, the operator or owner of system 900, or from other sources. In any event, AM control system 904 executes code 920, dividing support 100 and/or component 10 into a series of thin slices that it assembles using AM printer 906 in successive layers of powder. In the DMLM example, each layer may be melted or sintered to the exact geometry defined by code 920 and fused to the preceding layer. Subsequently, support 100 may be exposed to any variety of finishing processes, e.g., minor machining, sealing, polishing, assembly to another part, etc.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. “Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about,” “approximately” and “substantially,” are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise. “Approximately” as applied to a particular value of a range applies to both values, and unless otherwise dependent on the precision of the instrument measuring the value, may indicate +/−10% of the stated value(s).

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

What is claimed is:

1. A support positioned on a build plate of an additive manufacturing system, the support comprising:
a build surface;
a side surface positioned adjacent the build surface;
an outlet opening formed through the build surface, the outlet opening configured to be in fluid communication with an aperture formed through a surface of a component built above the build surface;
an inlet opening formed through one of the build surface or the side surface; and
a conduit fluidly coupling the outlet opening and the inlet opening.

2. The support of claim 1, further comprising:
at least one distinct outlet opening formed through the build surface, the at least one distinct outlet opening configured to be in fluid communication with at least one distinct aperture formed through the surface of the component built above the build surface.

3. The support of claim 2, further comprising:
at least one distinct inlet opening formed through one of:
the build surface,
the side surface, or
a distinct side surface positioned adjacent the build surface and the side surface; and
at least one distinct conduit fluidly coupling the at least one distinct outlet opening and the at least one distinct inlet opening.

4. The support of claim 2, wherein the conduit fluidly couples the inlet opening to the at least one distinct outlet opening formed through the build surface.

5. The support of claim 1, further comprising:
a joist positioned between the build surface and the surface of the component, the joist including a passage fluidly coupling the outlet opening formed through the build surface and the aperture formed through the surface of the component.

6. A build plate for an additive manufacturing system, the build plate comprising:
a top surface; and
a support positioned directly on the top surface, the support including:
a build surface;
a side surface positioned adjacent the build surface;
an outlet opening formed through the build surface, the outlet opening configured to be in fluid communication with an aperture formed through a surface of a component built above the build surface;
an inlet opening formed through one of the build surface or the side surface; and
a conduit fluidly coupling the outlet opening and the inlet opening.

7. The build plate of claim 6, wherein the support further includes:
at least one distinct outlet opening formed through the build surface, the at least one distinct outlet opening configured to be in fluid communication with at least one distinct aperture formed through the surface of the component built above the build surface.

8. The build plate of claim 7, wherein the support further comprises:
at least one distinct inlet opening formed through one of:
the build surface,
the side surface, or
a distinct side surface positioned adjacent the build surface and the side surface; and
at least one distinct conduit fluidly coupling the at least one distinct outlet opening and the at least one distinct inlet opening.

9. The build plate of claim 7, wherein the conduit fluidly couples the inlet opening to the at least one distinct outlet opening formed through the build surface.

10. The build plate of claim 6, further comprising:
a joist positioned between the build surface of the support and the surface of the component, the joist including a passage fluidly coupling the outlet opening formed through the build surface and the aperture formed through the surface of the component.

11. The build plate of claim 6, wherein the support is one of:
coupled directly to the top surface, or
built directly on the top surface using additive manufacturing.

12. The build plate of claim 6, further comprising:
a distinct support positioned one of:
directly on the top surface, adjacent the support, or
above the component built above the build surface of the support.

13. The build plate of claim 12, wherein the distinct support positioned above the component built above the build surface of the support includes:
a build surface configured to contact a surface including an aperture of a distinct component;
a side surface positioned adjacent the build surface; and
a bottom surface positioned opposite the build surface of the distinct support, the bottom surface configured to be positioned on the component built above the build surface of the support.

14. The build plate of claim 13, wherein the distinct support positioned above the component built above the build surface of the support further includes:
an outlet opening formed through one of the build surface or the bottom surface.

15. The build plate of claim 14, wherein the outlet opening of the distinct support formed through the build surface of the distinct support is configured to be in fluid communication with the aperture formed through the surface of the distinct component built above the build surface of the distinct support.

16. The build plate of claim 15, wherein the outlet opening of the distinct support formed through the bottom surface of the distinct support is configured to be in fluid communication with a distinct aperture formed through a distinct surface of the component built above the build surface of the support.

17. The build plate of claim 14, wherein the distinct support positioned above the component built above the build surface of the support further includes:
an inlet opening formed through one of:
the build surface of the distinct support, or
the side surface of the distinct support; and
a conduit fluidly coupling the outlet opening of the distinct support and the inlet opening.

18. An additive manufacturing system comprising:
a build plate including a top surface;
at least one laser positioned above the build plate; and
a support positioned directly on the top surface of the build plate, the support including:
a build surface;
a side surface positioned adjacent the build surface;
an outlet opening formed through the build surface, the outlet opening configured to be in fluid communication with an aperture formed through a surface of a component built above the build surface;
an inlet opening formed through one of the build surface or the side surface; and
a conduit fluidly coupling the outlet opening and the inlet opening.

19. The additive manufacturing system of claim 18, wherein the support further includes:
at least one distinct outlet opening formed through the build surface, the at least one distinct outlet opening configured to be in fluid communication with at least one distinct aperture formed through the surface of the component built above the build surface.

20. The additive manufacturing system of claim 19, wherein the support further comprises:
at least one distinct inlet opening formed through one of:
the build surface,
the side surface, or
a distinct side surface positioned adjacent the build surface and the side surface; and
at least one distinct conduit fluidly coupling the at least one distinct outlet opening and the at least one distinct inlet opening.
